(19) United States
(12) Patent Application Publication
(10) Pub. No.: US 2025/0134311 A1
(43) Pub. Date: May 1, 2025

(54) GRAVITY-TYPE DOUBLE-ENDED PEPPER GRINDER

(71) Applicant: NINGBO KAIDELI ELECTRIC CO., LTD, Ningbo (CN)

(72) Inventor: Songbiao Wang, Ningbo (CN)

(21) Appl. No.: 18/522,212

(22) Filed: Nov. 28, 2023

(30) Foreign Application Priority Data
Oct. 31, 2023 (CN) 202322928738.1

(51) Int. Cl. A47J 42/06; A47J 42/46

(52) U.S. Cl. CPC A47J 42/06; A47J 42/46

(57) ABSTRACT

A gravity-type double-ended pepper grinder includes a housing and a material storage cup. The material storage cup is partitioned into two material chambers. The housing is correspondingly provided with two independent material channels butted with the two material chambers respectively. Discharge ends of the material channels are provided with a grinding assembly separately. A control module and a power module for supplying power to the control module and the grinding assembly are mounted in the housing. The control module is electrically connected to the grinding assembly. A first ball switch for controlling the on-off of the power module and a second ball switch for controlling an operating state of the grinding assembly are arranged on the control module. The first ball switch and the second ball switch extend out of the surface of the housing.

### CROSS REFERENCE TO RELATED APPLICATIONS

The present application claims the benefit of Chinese Utility Model application No. 202322928738.1 filed on Oct. 31, 2023, the contents of which are incorporated herein by reference in their entirety.

### TECHNICAL FIELD

The present disclosure relates to the technical field of kitchen utensils, in particular to a gravity-type double-ended pepper grinder.

### BACKGROUND

In modern people's eating habits, condiments are often used to flavor food, and pepper and sea salt are commonly used condiments. Because of the improved food health requirements for modern people, a domestic pepper grinder for grinding granular condiments has emerged.

When in use, coarse-grained pepper and sea salt are placed in the pepper grinder and ground by a grinding device located at the bottom of the grinder. The grinding device generally includes an outer internal-grinding core arranged fixedly and an inner internal-grinding core rotatable relative to the outer internal-grinding core. The inner and outer internal-grinding cores together define a lower annular opening. When the inner internal-grinding core rotates relative to the outer internal-grinding core, pepper granules are ground by the internal-grinding cores to form pepper powder, which falls out of the annular opening and spills on food.

At present, most of the common pepper grinders in the market can grind only one condiment at the same time. There are also a few double-ended grinders. For example, in the Chinese patent application “Double-ended Food Condiment Grinder”, No. CN201220385615.7, a grinding assembly and a material barrel are included. Both ends of the material barrel are opened, and the material barrel is partitioned into two separate spaces by a partition. The grinding assembly is respectively threaded to openings at both ends of the material barrel. Compared with the prior art, the double-ended food condiment grinder may grind two condiments at the same time, thus improving the grinding efficiency and being convenient to use.

For another example, in the Chinese patent application “Double-purpose Electric Condiment Grinder”, No. CN200920008235.X, an elongated hollow housing and two condiment containers (which may contain, for example, salt and pepper) are included. One end of the housing is provided with an upright base supporting the grinder, and the other end has a spherical top. A one-way rotary grinding device is located at a side opening of each condiment container. The side openings are located on the opposite sides of the housing, and an inclination switch controls the direction of a commutative motor. A one-way clutch is provided in a transmission device. In this way, each grinding device is selectively rotated according to the rotation direction of the motor output. Therefore, after the grinder rotates at an acute angle from an upright position, the selected side opening faces down. In this way, a user may pour condiments from either condiment container, which is particularly suitable for people with limited nimbleness.

Although the grinder realizes the grinding of two condiments, the product is inconvenient to use to some extent. The present disclosure further improves the use convenience of the grinder product.

### SUMMARY

To solve the technical problems, the present disclosure provides a gravity-type double-ended pepper grinder. By optimizing the structure of the grinder, the grinder is more convenient to use.

The present disclosure adopts the following technical solutions. The gravity-type double-ended pepper grinder includes a housing and a material storage cup. The material storage cup is partitioned into two material chambers. The housing is correspondingly provided with two independent material channels butted with the two material chambers respectively. Discharge ends of the material channels are provided with a grinding assembly separately. A control module and a power module for supplying power to the control module and the grinding assembly are mounted in the housing. The control module is electrically connected to the grinding assembly. A first ball switch for controlling the on-off of the power module and a second ball switch for controlling an operating state of the grinding assembly are arranged on the control module. The first ball switch and the second ball switch extend out of the surface of the housing.

Compared with the prior art, the present disclosure has the following advantages. Firstly, two independent material channels are arranged in the housing and butted with the two material chambers of the material storage cup respectively, and the discharge ends of the material channels are provided with a grinding assembly separately. In this way, the grinder of the present disclosure can grind two granules without being replaced or cleaned. Secondly, different from the prior art in which the grinders are controlled mostly by using a button switch, the grinder of the present disclosure is controlled by ball switches. In addition, the first ball switch is further configured to control the on-off of the power module, and the second ball switch is configured to control the operating state of the grinding assembly, which is convenient for a user to use. The user can directly control the first ball switch and the second ball switch on the surface of the housing, and therefore, the user experience is good.

In some embodiments of the present disclosure, the first ball switch is arranged vertically, the second ball switch is arranged horizontally, and the first ball switch and the second ball switch are perpendicular to each other.

Specifically, a ball in the first ball switch may roll vertically under the gravity of the ball, so as to switch the on-off of the power module. The second ball switch is controlled by the user to realize the switching between forward rotation and reverse rotation of the driving motor.

A built-in gravity sensor is adopted to realize a gravity sensing function of a conventional grinder. However, the function of the grinder of the present disclosure is realized by the design of the first ball switch. Specifically, when the grinder of the present disclosure is placed upright, the ball in the first ball switch arranged vertically falls down to the end close to the material storage cup under the gravity of the ball, the power module is in an off state, and the grinding assembly does not operate. When the grinder of the present disclosure is inverted, the ball in the first ball switch falls down to the end away from the material storage cup under the gravity of the ball, the power module is in an on state, and the grinding assembly operates.

By reasonably arranging the first ball switch in the grinder of the present disclosure, the grinding assembly can be controlled to operate by gravity sensing, thus realizing mechanical automatic grinding.

In some embodiments of the present disclosure, a driving motor is mounted in the housing. The driving motor is connected to a transmission gear. The transmission gear is connected to the two grinding assemblies. Specifically, an output shaft of the driving motor is connected to the transmission gear through a speed change gear box. The driving motor outputs power to the grinding assembly through the transmission gear, and drives the grinding assembly to operate.

In some embodiments of the present disclosure, the grinding assembly includes a mold core, a driven gear, and a driving wheel. The driven gear is meshed with the transmission gear. The driving wheel is meshed with the driven gear. The driving wheel rotates to drive the mold core to rotate.

In some embodiments of the present disclosure, the grinding assembly further includes a transmission shaft. The mold core, the driving wheel, and the driven gear are sequentially sleeved outside the transmission shaft. Gear teeth are arranged on a peripheral surface of the driven gear and meshed with a driving gear. A circle of groove teeth are arranged on an upper surface of the driven gear. Another circle of groove teeth are arranged on a bottom surface of the driving wheel correspondingly. The driven gear is meshed with the driving wheel. At this point, the driving gear rotates to drive the driven gear to rotate, and the driven gear rotates to drive the driving wheel to rotate. In the present disclosure, the mold core, the driven gear, and the driving wheel are arranged coaxially through the arrangement of the transmission shaft.

In some embodiments of the present disclosure, the transmission shaft includes a free segment and a linkage segment. The free segment has a circular cross section, the driven gear is sleeved outside the free segment, and the driven gear is forced to rotate around the free segment. The linkage segment has a non-circular cross section, the mold core is sleeved outside the linkage segment, and the driving wheel rotates to drive the mold core to rotate through the transmission shaft.

In the present disclosure, the driving wheel may be directly sleeved outside the linkage segment, so that the driving wheel and the transmission shaft do not rotate relative to each other, and the driving wheel may also be fixedly connected to the transmission shaft.

In some embodiments of the present disclosure, the groove teeth are inclined triangular sharp teeth, and the groove teeth of the driven gears in the two grinding assemblies are inclined oppositely.

In the present disclosure, in order to move the driving wheel more smoothly, it is preferable to design the driving wheel to move up and down with a predetermined stroke in an axial direction of the transmission shaft, and to design an elastic member to apply a force so that the driving wheel can keep meshed with the driven gear.

In some embodiments of the present disclosure, the driven gears of the two grinding assemblies are arranged on a left side and a right side of the transmission gear. The transmission gear rotates clockwise to drive the two driven gears to rotate counterclockwise. The two driven gears rotating counterclockwise drive only one of the driving wheels to rotate.

In the present disclosure, clockwise and counterclockwise represent only two opposite rotation directions and are not limited to specific rotation directions thereof.

Since the groove teeth of the two driven gears are inclined oppositely, one of the driven gears rotates clockwise to drive the driving wheel to rotate synchronously, while the driven gear rotates counterclockwise to drive the driving wheel not to rotate. The other driven gear rotates counterclockwise to drive the driving wheel to rotate synchronously, while the driven gear rotates clockwise to drive the driving wheel not to rotate. Therefore, the transmission gear designed in the present disclosure rotates in different directions to drive different grinding assemblies to operate.

In some embodiments of the present disclosure, the second ball switch is switched to control the forward or reverse rotation of the driving motor and to drive the transmission gear to rotate clockwise or counterclockwise. That is, the second ball switch controls one of the grinding assemblies to operate while the other grinding assembly does not operate.

On the basis of conforming to the common sense in the art, the above implementations may be arbitrarily combined.

### BRIEF DESCRIPTION OF THE DRAWINGS

The present disclosure will be described in further detail below in conjunction with the accompanying drawings and preferred embodiments, but those skilled in the art will appreciate that these drawings are drawn solely for the purpose of explaining the preferred embodiments and therefore should not be taken as limiting the scope of the present disclosure. Furthermore, unless specifically noted, the drawings are schematic only to conceptually represent the composition or construction of the described object and may contain exaggerated display, and are not necessarily drawn to scale.

FIG. 1 is a structure diagram of the present disclosure.

FIG. 2 is a cross-sectional view of the present disclosure.

FIG. 3 is an internal structure diagram 1 of the present disclosure.

FIG. 4 is an internal structure diagram 2 of the present disclosure.

The reference signs are specified as follows: 1. housing; 2. material storage cup; 3. material chamber; 4. material channel; 5. control module; 6. power module; 7. first ball switch; 8. second ball switch; 9. driving motor; 10. transmission gear; 11. mold core; 12. driven gear; 13. driving wheel; 14. transmission shaft; 15. groove tooth.

### DETAILED DESCRIPTION

The present disclosure will be described in detail below with reference to the accompanying drawings.

In order that the objects, technical solutions, and advantages of the present disclosure will be more clearly understood, the present disclosure will be further described in detail hereinafter with reference to the accompanying drawings and embodiments. It should be understood that specific embodiments described herein are merely illustrative of the present disclosure and are not intended to be limiting thereof.

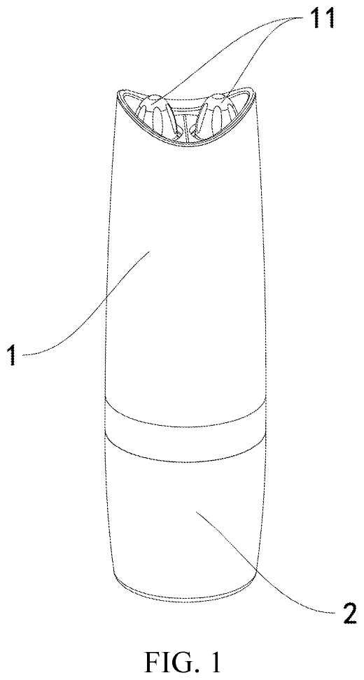

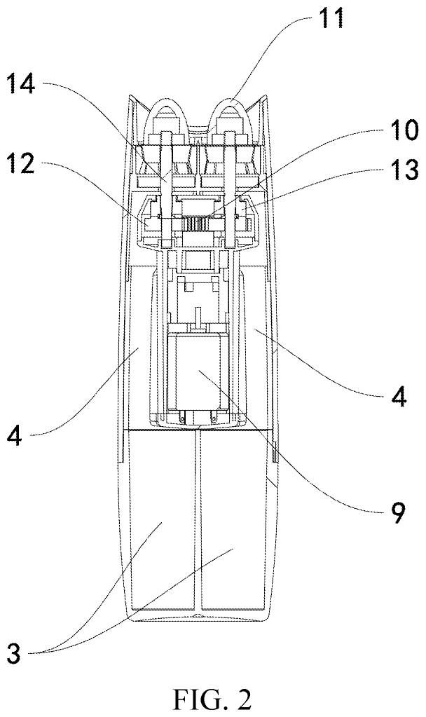

In Embodiment 1, as shown in FIG. 1 and FIG. 2, a gravity-type double-ended pepper grinder includes a housing 1 and a material storage cup 2. The material storage cup 2 is partitioned into two material chambers 3. The housing 1 is correspondingly provided with two independent material channels 4 butted with the two material chambers 3 respectively. Discharge ends of the material channels 4 are provided with a grinding assembly separately. In this way, the grinder of the present disclosure can grind two granules without being replaced or cleaned.

A control module 5 and a power module 6 for supplying power to the control module 5 and the grinding assembly are mounted in the housing 1. The control module 5 is electrically connected to the grinding assembly. A first ball switch 7 for controlling the on-off of the power module 6 and a second ball switch 8 for controlling an operating state of the grinding assembly are arranged on the control module 5. The first ball switch 7 and the second ball switch 8 extend out of the surface of the housing 1. Different from the prior art in which the grinders are controlled mostly by using a button switch, the grinder of the present disclosure is controlled by ball switches and can be more conveniently used by a user, and the user experience is good.

The first ball switch 7 is arranged vertically, the second ball switch 8 is arranged horizontally, and the first ball switch 7 and the second ball switch 8 are perpendicular to each other. Specifically, a ball in the first ball switch 7 rolls vertically under the gravity of the ball. The second ball switch 8 is controlled by the user to realize the switching between forward rotation and reverse rotation of the driving motor 9.

In the present disclosure, the first ball switch 7 arranged vertically is configured to control the on-off of the power module 6. A built-in gravity sensor is adopted to realize a gravity sensing function of a conventional grinder. However, the function of the grinder of the present disclosure is realized by the design of the first ball switch 7. Specifically, when the grinder of the present disclosure is placed upright, the ball in the first ball switch 7 arranged vertically falls down to the end close to the material storage cup 2 under the gravity of the ball, the power module 6 is in an off state, and the grinding assembly does not operate. When the grinder of the present disclosure is inverted, the ball in the first ball switch 7 is away from the material storage cup 2 under the gravity of the ball, the power module 6 is in an on state, and the grinding assembly operates.

By reasonably arranging the first ball switch 7 in the grinder of the present disclosure, the grinding assembly can be controlled to operate by gravity sensing, thus realizing mechanical automatic grinding.

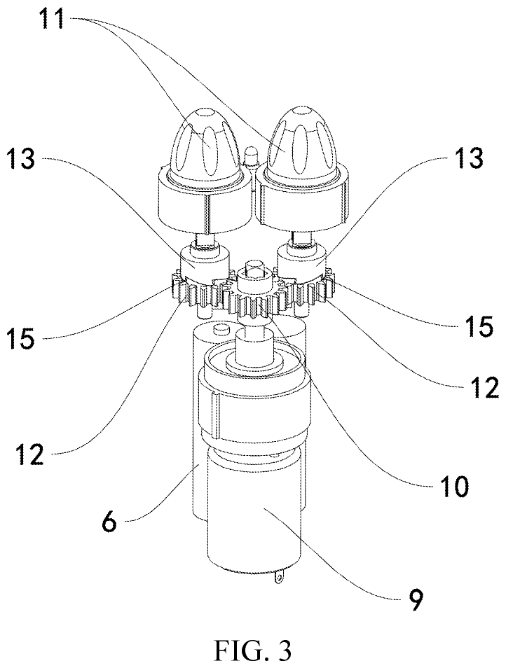

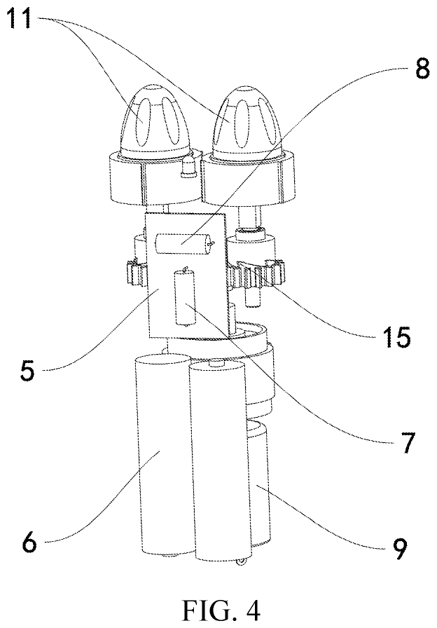

In Embodiment 2, as shown in FIG. 1 to FIG. 4, a driving motor 9 is mounted in the housing 1. The driving motor 9 is connected to a transmission gear 10. The transmission gear 10 is connected to the two grinding assemblies. Specifically, an output shaft of the driving motor 9 is connected to the transmission gear 10 through a speed change gear box. The driving motor 9 outputs power to the grinding assembly through the transmission gear 10, and drives the grinding assembly to operate.

The grinding assembly includes a mold core 11, a driven gear 12, and a driving wheel 13. The driven gear 12 is meshed with the transmission gear 10. The driving wheel 13 is meshed with the driven gear 12. The driving wheel 13 rotates to drive the mold core 11 to rotate. The grinding assembly further includes a transmission shaft 14. The mold core 11, the driving wheel 13, and the driven gear 12 are sequentially sleeved outside the transmission shaft 14. Gear teeth are arranged on a peripheral surface of the driven gear 12 and meshed with a driving gear. A circle of groove teeth 15 are arranged on an upper surface of the driven gear 12. Another circle of groove teeth 15 are arranged on a bottom surface of the driving wheel 13 correspondingly. The driven gear 12 is meshed with the driving wheel 13. At this point, the driving gear rotates to drive the driven gear 12 to rotate, and the driven gear 12 rotates to drive the driving wheel 13 to rotate. In the present disclosure, the mold core 11, the driven gear 12, and the driving wheel 13 are arranged coaxially through the arrangement of the transmission shaft 14.

The transmission shaft 14 includes a free segment and a linkage segment. The free segment has a circular cross section, the driven gear 12 is sleeved outside the free segment, and the driven gear 12 is forced to rotate around the free segment. The linkage segment has a non-circular cross section, the mold core 11 is sleeved outside the linkage segment, and the driving wheel 13 rotates to drive the mold core 11 to rotate through the transmission shaft 14. In the present disclosure, the driving wheel 13 may be directly sleeved outside the linkage segment, so that the driving wheel 13 and the transmission shaft 14 do not rotate relative to each other, and the driving wheel 13 may also be fixedly connected to the transmission shaft 14. Specifically, the cross section of the linkage segment may be triangular, rectangular, irregular, and so on.

The groove teeth 15 are inclined triangular sharp teeth, and the groove teeth 15 of the driven gears 12 in the two grinding assemblies are inclined oppositely. In the present disclosure, in order to move the driving wheel 13 more smoothly, it is preferable to design the driving wheel 13 to move up and down with a predetermined stroke in an axial direction of the transmission shaft 14, and to design an elastic member to apply a force so that the driving wheel 13 can keep meshed with the driven gear 12.

The driven gears 12 of the two grinding assemblies are arranged on a left side and a right side of the transmission gear 10. The transmission gear 10 rotates clockwise to drive the two driven gears 12 to rotate counterclockwise. The two driven gears 12 rotating counterclockwise drive only one of the driving wheels 13 to rotate. In the present disclosure, clockwise and counterclockwise represent only two opposite rotation directions and are not limited to specific rotation directions thereof.

Since the groove teeth 15 of the two driven gears 12 are inclined oppositely, one of the driven gears 12 rotates clockwise to drive the driving wheel 13 to rotate synchronously, while the driven gear 12 rotates counterclockwise to drive the driving wheel 13 not to rotate. The other driven gear 12 rotates counterclockwise to drive the driving wheel 13 to rotate synchronously, while the driven gear 12 rotates clockwise to drive the driving wheel 13 not to rotate. Therefore, the transmission gear 10 designed in the present disclosure rotates in different directions to drive different grinding assemblies to operate.

The second ball switch 8 is switched to control the forward or reverse rotation of the driving motor 9 and to drive the transmission gear 10 to rotate clockwise or counterclockwise. That is, the second ball switch 8 controls one of the grinding assemblies to operate while the other grinding assembly does not operate.

Other contents of Embodiment 2 are the same as those of Embodiment 1.

The present disclosure has been described in detail above, and the principles and implementations of the present disclosure have been set forth herein using specific examples. The above embodiments have been set forth only to aid in the understanding of the present disclosure and core ideas. It is to be noted that those of ordinary skill in the art may make numerous improvements and modifications to the present disclosure without departing from the principles of the present disclosure. Such improvements and modifications are intended to be within the scope of protection of the appended claims of the present disclosure.

What is claimed is:

1. A gravity-type double-ended pepper grinder, comprising a housing (1) and a material storage cup (2),
wherein the material storage cup (2) is partitioned into two material chambers (3);
the housing (1) is correspondingly provided with two independent material channels (4) butted with the two material chambers (3) respectively, and a discharge end of each of the two material channels (4) is provided with a grinding assembly;
a control module (5) and a power module (6) for supplying power to the control module (5) and the grinding assembly are mounted in the housing (1);
the control module (5) is electrically connected to the grinding assembly;
a first ball switch (7) for controlling on-off of the power module (6) and a second ball switch (8) for controlling an operating state of the grinding assembly are arranged on the control module (5); and the first ball switch (7) and the second ball switch (8) extend out of a surface of the housing (1).

2. The gravity-type double-ended pepper grinder according to claim 1, wherein the first ball switch (7) is arranged vertically, the second ball switch (8) is arranged horizontally, and the first ball switch (7) and the second ball switch (8) are perpendicular to each other.

3. The gravity-type double-ended pepper grinder according to claim 1, wherein a ball in the first ball switch (7) rolls vertically under a gravity of the ball.

4. The gravity-type double-ended pepper grinder according to claim 1, wherein a driving motor (9) is mounted in the housing (1), the driving motor (9) is connected to a transmission gear (10), and the transmission gear (10) is connected to two grinding assemblies of the two material channels.

5. The gravity-type double-ended pepper grinder according to claim 4, wherein the grinding assembly comprises a mold core (11), a driven gear (12), and a driving wheel (13); the driven gear (12) is meshed with the transmission gear (10), and the driving wheel (13) is meshed with the driven gear (12); and the driving wheel (13) rotates to drive the mold core (11) to rotate.

6. The gravity-type double-ended pepper grinder according to claim 5, wherein the grinding assembly further comprises a transmission shaft (14); the mold core (11), the driving wheel (13), and the driven gear (12) are sequentially sleeved outside the transmission shaft (14); gear teeth are arranged on a peripheral surface of the driven gear (12) and meshed with a driving gear; a circle of groove teeth (15) are arranged on an upper surface of the driven gear (12), and another circle of groove teeth (15) are arranged on a bottom surface of the driving wheel (13) correspondingly; and the driven gear (12) is meshed with the driving wheel (13).

7. The gravity-type double-ended pepper grinder according to claim 6, wherein the transmission shaft (14) comprises a free segment and a linkage segment; the free segment has a circular cross section, the driven gear (12) is sleeved outside the free segment, and the driven gear (12) is forced to rotate around the free segment; and the linkage segment has a non-circular cross section, the mold core (11) is sleeved outside the linkage segment, and the driving wheel (13) rotates to drive the mold core (11) to rotate through the transmission shaft (14).

8. The gravity-type double-ended pepper grinder according to claim 6, wherein the groove teeth (15) are inclined triangular sharp teeth, and the groove teeth (15) of the driven gears (12) in the two grinding assemblies are inclined oppositely.

9. The gravity-type double-ended pepper grinder according to claim 8, wherein the driven gears (12) of the two grinding assemblies are arranged on a left side and a right side of the transmission gear (10), the transmission gear (10) rotates clockwise to drive the two driven gears (12) to rotate counterclockwise, and the two driven gears (12) rotating counterclockwise drive only one of the driving wheels (13) to rotate.

10. The gravity-type double-ended pepper grinder according to claim 9, wherein the second ball switch (8) is switched to control the forward or reverse rotation of the driving motor (9) and to drive the transmission gear (10) to rotate clockwise or counterclockwise.

11. The gravity-type double-ended pepper grinder according to claim 7, wherein the groove teeth (15) are inclined triangular sharp teeth, and the groove teeth (15) of the driven gears (12) in the two grinding assemblies are inclined oppositely.

12. The gravity-type double-ended pepper grinder according to claim 11, wherein the driven gears (12) of the two grinding assemblies are arranged on a left side and a right side of the transmission gear (10), the transmission gear (10) rotates clockwise to drive the two driven gears (12) to rotate counterclockwise, and the two driven gears (12) rotating counterclockwise drive only one of the driving wheels (13) to rotate.

13. The gravity-type double-ended pepper grinder according to claim 12, wherein the second ball switch (8) is switched to control the forward or reverse rotation of the driving motor (9) and to drive the transmission gear (10) to rotate clockwise or counterclockwise.
